(19) United States
(12) Patent Application Publication
(10) Pub. No.: US 2020/0380892 A1
(43) Pub. Date: Dec. 3, 2020

(54) WIRE SIGN HOLDER

(71) Applicant: Vanguard Packaging, LLC, KANSAS CITY, MO (US)

(72) Inventors: Ryan J. Hughes, Weatherby Lake, MO (US); Matthew Luczak, Kansas City, MO (US)

(21) Appl. No.: 16/885,803

(22) Filed: May 28, 2020

Related U.S. Application Data
(60) Provisional application No. 62/854,211, filed on May 29, 2019.

(51) Int. Cl. G09F 7/18; G09F 23/00

(52) U.S. Cl. CPC G09F 7/18; G09F 2007/1856; G09F 23/00

(57) ABSTRACT

For securing a display sign to a display rack, a wire sign holder with a main length of a wire, one or more hook(s) at one end of the main length of wire, and a bracket situated at the other end of the main length of wire. The wire sign holder is configured such that the bracket connects to an in-store fixture or display rack and holds the main length of wire vertically. While in the vertical position, the one or more hook(s) at the other end of the main length of wire is situated to receive a display sign. Multiple wire sign holders are attached to a display rack for securing one or more display signs.

### CROSS-REFERENCE TO RELATED APPLICATION

This application claims the benefit of U.S. Provisional Patent Application No. 62/854,211 filed May 29, 2019, which is incorporated by reference herein in its entirety.

### FIELD OF THE INVENTION

The present invention relates generally to display sign holders. More specifically, the present invention is concerned with a unique way to hang promotional signage by using signage brackets to attach to existing warehouse racking already set-up in a retail environment. These brackets are made out of wire/sheet metal and create a stable permanent solution for retail promotional signage applications.

### BACKGROUND OF THE INVENTION

Currently, to hang promotional signage on warehouse racks, one must buy plastic hardware that limits where the promotional signage can be installed. When using existing hardware, one must physically adhere/apply the promotional signage for attachment. Utilizing current options, one likely must use tools and/or other means to tear down promotional signage.

Accordingly, there exists a need for display sign holders, which are universal in installation location, do not need tools to install, do not require adhesives, work with multiple sign designs, and are easily uninstalled.

### SUMMARY OF THE INVENTION

The present invention comprises a wire sign holder. The wire sign holder generally includes three parts—a main length of a wire, one or more hook(s) at one end of the main length of wire; and a bracket situated at the other end of the main length of wire. The wire sign holder is configured such that the bracket connects to an in-store fixture or display rack and holds the main length of wire vertically. While in the vertical position, the one or more hook(s) at the other end of the main length of wire is situated to receive a display sign.

Also contemplated is a method of utilizing multiple wire sign holders to display a single sign. In this configuration, two or more wire sign holders would be situated vertically while connected to an in-store fixture or display rack. A single sign would then be configured to be secured to and rest upon each of the hooks of the wire sign holders. In this way, a single sign which covers a large span is supported substantially along its length. Additionally, it is contemplated that a series of wire sign holders are used to display large signs or a series of signs which work together to create a single advertisement, image, or impression. In this way, the wire sign holders are configured to each have multiple hooks, where each hook can be utilized to independently hold a single corner of each discrete sign.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings.

FIG. 1 is a front elevation view rotated 90 degrees counterclockwise of a first wire sign holder of the present invention.

FIG. 2 is a right side elevation view rotated 90 degrees counterclockwise of the wire sign holder of FIG. 1.

FIG. 3 is a top plan view of the wire sign holder of FIG. 1.

FIG. 4 is a front perspective view of a second wire sign holder of the present invention.

FIG. 5 is a top plan view of the wire sign holder of FIG. 4.

FIG. 6 is a right side elevation view rotated 90 degrees counterclockwise of the wire sign holder of FIG. 4.

FIG. 7 is a front elevation view rotated 90 degrees counterclockwise of the wire sign holder of FIG. 4.

FIG. 8 depicts multiple wire sign holders of FIG. 1 in use with multiple signs.

FIG. 9 depicts the scene of FIG. 8, showing further detail on how the signs interact with the wire sign holder.

FIG. 10 depicts the scene of FIG. 8, showing further detail on how the signs interact with the wire sign holder.

FIG. 11 depicts the scene of FIG. 8, showing further detail on how the signs interact with the wire sign holder.

### DETAILED DESCRIPTION

As required, a detailed embodiment of the present invention is disclosed herein. It is to be understood that the disclosed embodiment merely exemplifies the principles of the invention, which may be embodied in various forms. Therefore, the specific structural and functional details disclosed herein cannot be interpreted as limiting, but merely as a basis for the claims and as a representative basis for teaching one skilled in the art to variously employ the present invention in these and other detailed structure.

In some embodiments, a wire sign holder is included. Turning to the figures, in some embodiments, the wire sign holder has a main body 110. In some embodiments, the main body is an elongated wire, typically made of metal or an otherwise rigid material such as, for example, plastic. In some embodiments, the main body is elongated, having a first end and a second end. In some embodiments, a length of wire 120 is attached to the first end of the main body. In some embodiments, said length of wire is bent into a hook configuration 122. In some embodiments, the hook configuration is configured to received and secure a sign. In some embodiments, the second end of the main body is attached to a bracket 130. In some embodiments, the bracket is configured to vertically secure the wire sign holder by interfacing with a display rack 310. In some embodiments, the second end of the main body is attached to a slide bracket. In some embodiments, the slide bracket has teeth 132. In some embodiments, the teeth 132 of the slide bracket 130 are configured to interface with a display rack 310. In some embodiments, the slide bracket 130 is configured to vertically secure the wire sign holder when the teeth 132 of the slide bracket interface with a display rack 310. In some embodiments, the slide bracket with teeth does not comprise a securing mechanism, such as, for example, a thumb screw or other fastener. In some embodiments, the wire sign holder, with a slide bracket proximate to or at the second end of the main body, does not have a bend or curve proximate to the second end of the main body.

In some embodiments, the wire sign holder includes a main body 110. In some embodiments, the main body has a length, width, and height, each with a corresponding axis. In some embodiments, the main body consists of a wire. In some embodiments, the wire has a circular cross-sectional profile. In some embodiments, the wire has some other geometric cross-sectional profile. It will be appreciated that the wire can be a multitude of colors. In some embodiments, the wire is made of a metal, while in yet some other embodiments, the wire is made of a plastic. In some embodiments, the wire is made of yet another material. In some embodiments, the wire is configured in a substantially straight geometry. In some embodiments, the wire is configured in a curved or otherwise deformed geometry. In some embodiments, such deformed geometry is to conform to the needs of the space in which the wire sign holder will be utilized.

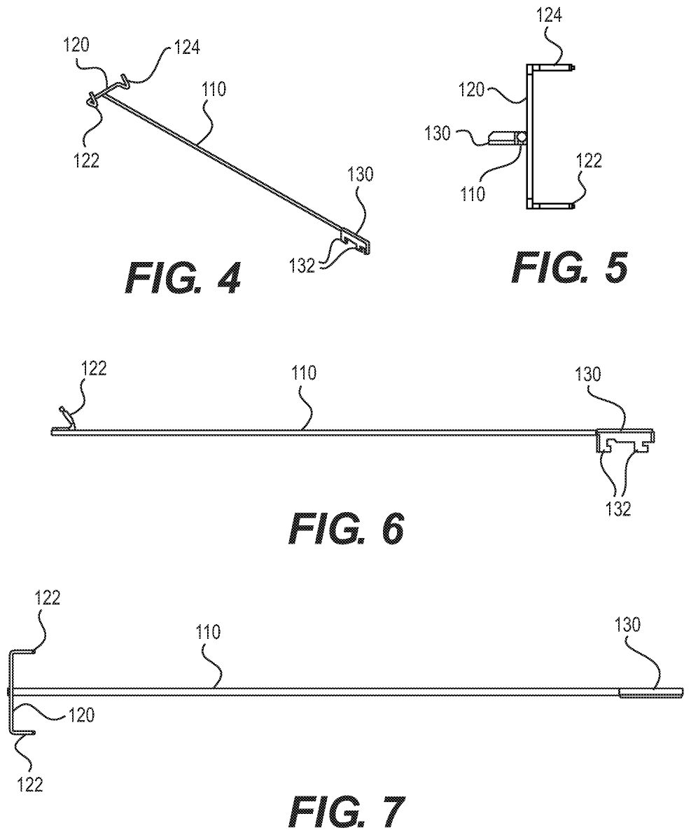

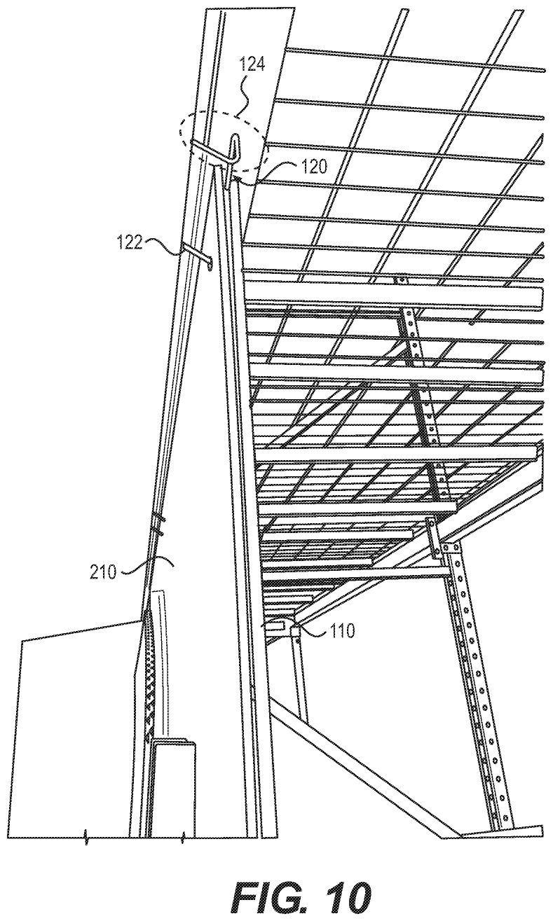

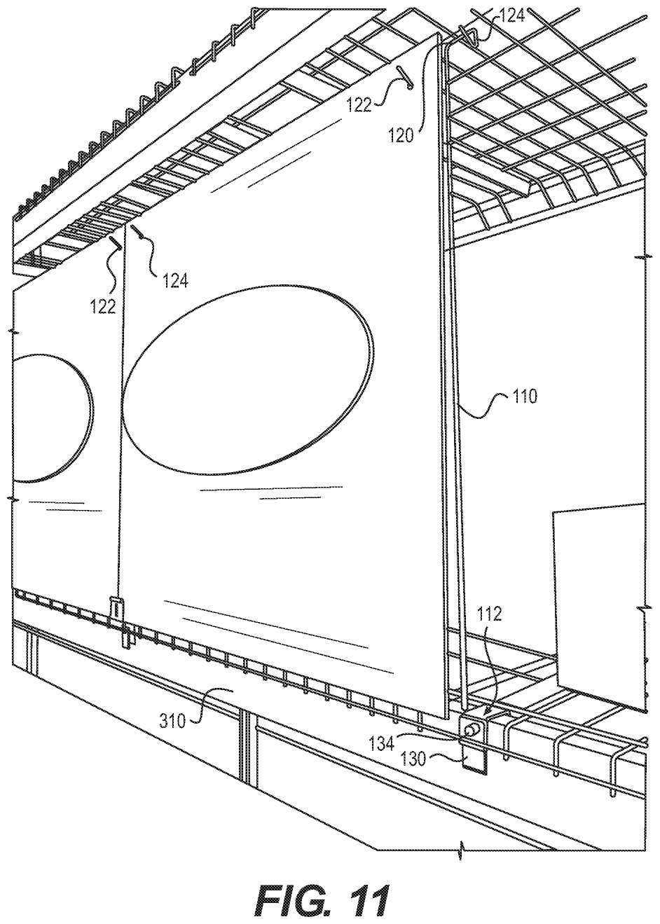

In some embodiments, the main body of the wire sign holder has a first end. In some embodiments, a second length of wire 120 is attached substantially proximate to the first end of the main body. In some embodiments, the second wire has a circular cross-sectional profile. In some embodiments, the second wire has some other geometric cross-sectional profile. It will be appreciated that the second wire can be a multitude of colors. In some embodiments, the second wire is made of a metal, while in yet some other embodiments, the second wire is made of a plastic. In some embodiments, the second wire is made of yet another material. In some embodiments, the second wire is configured in a bent configuration, such as to form at least one hook, as shown for example, in FIGS. 2, 4, 6, 10, and 11. In some embodiments, the wire is bent to form more than one hook 122/124, as shown, for example, in FIG. 4. In some embodiments, the wire is bent to form two opposing hooks. In some embodiments, the hooks are configured to receive, hold, and/or support a display sign 210 by way of attachment to the hooks 122/124, as shown, for example, in FIGS. 10 and 11.

Turning to FIGS. 2 and 3, in some embodiments, the main body of the wire sign holder has a second end. In some embodiments, the second end is curved or bent to form a terminal end 112 that is angled out of the plane formed by the first and second wires. In some embodiments, the second end is curved or bent so that a portion (i.e., terminal end 112) of the length of the main body runs perpendicular to the rest of the main body. In some embodiments, a bracket 130 is attached to the perpendicular portion. In some embodiments, this attachment is achieved through welding. In some embodiments, this attachment is achieved through adhesive. In some embodiments, this attachment is achieved in a manner known to those ordinarily skilled in the art.

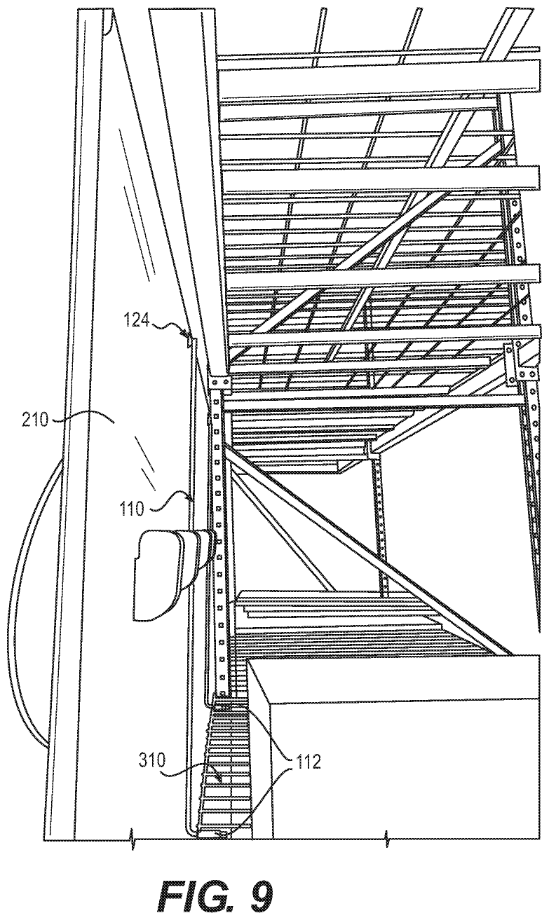

In some embodiments, the bracket has a main body portion. In some embodiments, the bracket has a first arm extending from the main body portion. In some embodiments, the bracket has a second arm extending from the main body portion. In some embodiments, the length of the main body, first arm, and/or second arm of the bracket are variable. In some embodiments, the bracket is configured to engage with a portion of a display rack 310. In some embodiments, the bracket is configured to hold the main body in a substantially vertical position when receiving a portion of a display rack, as shown, for example, in FIGS. 9-11.

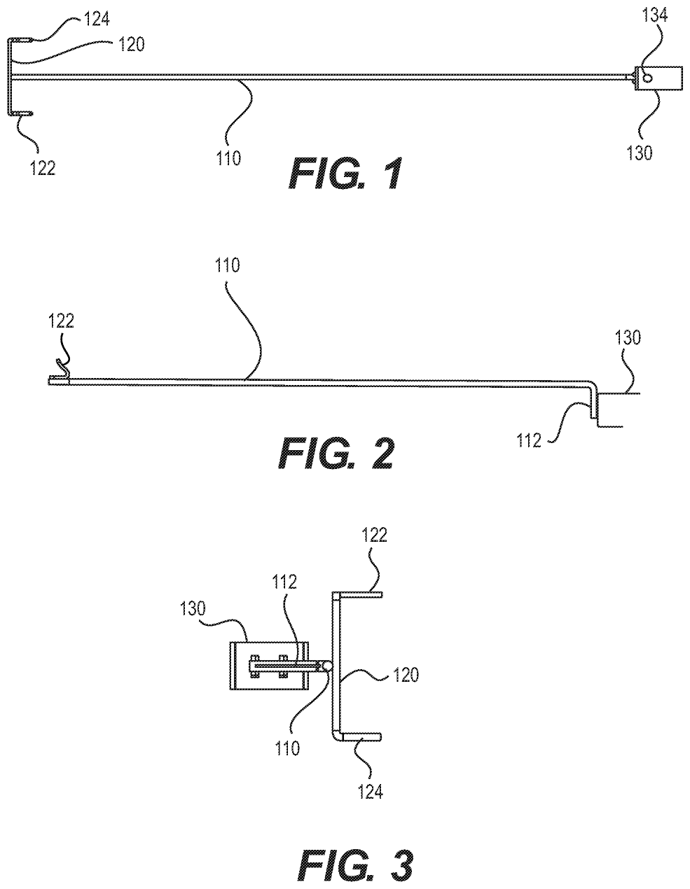

In some embodiments, the bracket has a securing mechanism 134. In some embodiments, the securing mechanism is a thumb screw. In some embodiments, the securing mechanism passes through the main body portion of the bracket, as shown, for example, in FIGS. 1 and 11. In some embodiments, the securing mechanism passes through an arm of the bracket. In some embodiments, the securing mechanism is configured to be tightened when engaging a display rack, thereby subsequently securing the bracket and the wire sign holder to the display rack. In some embodiments, the bracket with a securing mechanism does not comprise teeth. In some embodiments, the bracket with a securing mechanism is not a slide bracket.

Turning to FIGS. 4 and 6, in some embodiments, the bracket 130 is a slide bracket. In some embodiments, the slide bracket has a main body segment. In some embodiments, one or more tooth 132 is present on a face of the main body segment of the slide bracket. In some embodiments, the one or more tooth 132 is configured to interface with the display rack 310, such as by engaging with corresponding slots defined by a display rack. In some embodiments, the one or more tooth 132 is configured to hold the main body in a substantially vertical position when the one or more tooth is engaged with the display rack. In some embodiments, the one or more tooth 132 remains engaged with the display rack, thereby resisting the force of gravity.

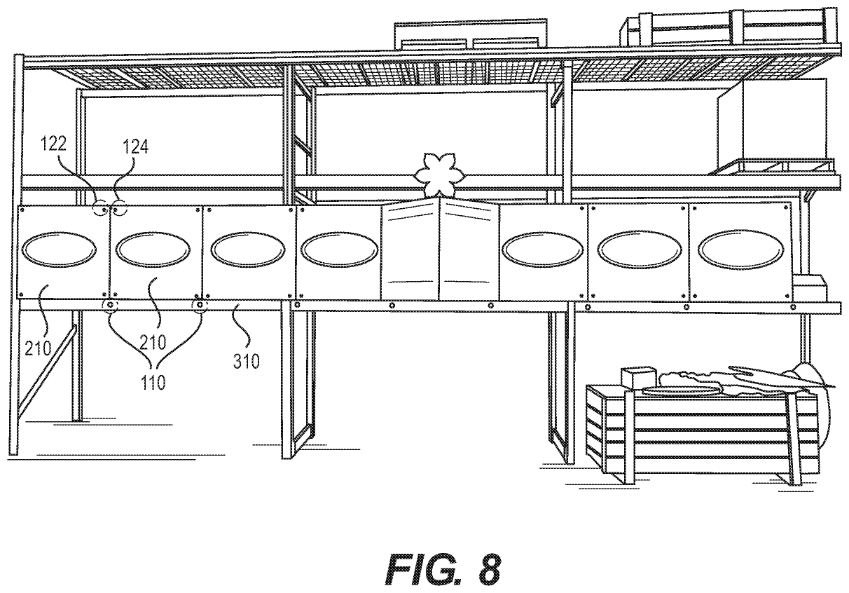

Turning to FIGS. 8-11, in some embodiments, two or more wire sign holders are utilized to hold a sign 210. In some embodiments, the two or more wire sign holders are spaced apart while secured to a display rack. In some embodiments, each of the two or more wire sign holders supports at least part of one end of one or more sign, while another of the two or more wire sign holders supports at least part of a second end of one or more sign. In this manner, a series of wire sign holders secured to a display rack are configured to hold many signs, as depicted, for example, in FIG. 8. Alternatively, a series of wire sign holder secured to a display rack are also configurable to support a single large sign.

The present invention also contemplates a method of hanging display signs. In some embodiments, the method includes forming a wire sign holder, said wire sign holder configured to be vertically secured to a display rack and to fully and/or partially support one or more sign. In some embodiments, the method includes securing one or more wire sign holder to a display rack, such as by utilizing a bracket of the wire sign holder and/or a thumb screw or other securing method. In some embodiments, the method includes hanging a sign or multiple signs on one or more wire sign holder, thereby securing the sign is a display position.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; and the new and useful structures, devices, elements, arrangements, parts and combinations, are set forth in the appended claims.

It is also to be understood that any following claims are intended to cover all of the generic and specific features of the invention herein described, and all statements of the scope of the invention which, as a matter of language, might be said to fall therebetween.

1. A wire sign holder comprising a first length of a wire having a first end and a second end; a first hook proximate to the first end of the first length of wire; and a bracket proximate to the second end of the first length of wire.

2. The wire sign holder of claim 1 comprising a second length of wire having a first end and a second end and positioned (a) proximate to the first end of the first length of wire and (b) perpendicular to the first length of wire, wherein the first hook is positioned proximate to the first end of the second length of wire.

3. The wire sign holder of claim 2 comprising a second hook positioned proximate to the second end of the second length of wire.

4. The wire sign holder of claim 1, wherein the first length of wire is bent near the second end of first length of wire to form a terminal end.

5. The wire sign holder of claim 4, wherein the bracket is attached to the terminal end.

6. The wire sign holder of claim 5, wherein the bracket comprises a securing mechanism.

7. The wire sign holder of claim 6, wherein the bracket is attached to a display rack via the securing mechanism.

8. The wire sign holder of claim 6, wherein the securing mechanism is a thumb screw.

9. The wire sign holder of claim 1, wherein the bracket is a slide bracket comprising one or more teeth.

10. The wire sign holder of claim 9, wherein the one or more teeth are engaged with a display rack.

11. The wire sign holder of claim 9, wherein the slide rack does not comprise a securing mechanism.

12. The wire sign holder of claim 1, wherein the first length of wire comprises a metal.

13. The wire sign holder of claim 1, wherein the first length of wire comprises is straight.

14. A display comprising:
(a) a wire sign holder comprising
(i) a first length of a wire having a first end and a second end,
(ii) a first hook proximate to the first end of the first length of wire, and
(iii) a bracket proximate to the second end of the first length of wire;
(b) a display sign; and
(c) a display rack.

15. The display of claim 14,
wherein the wire sign holder comprises (iv) a second hook, and (v) a second length of wire having a first end and a second end,
wherein the second length of wire is positioned perpendicular to the first length of wire and proximate to the first end of the first length of wire, and
wherein the first hook is positioned proximate to the first end of the second length of wire and the second hook is positioned proximate to the second end of the second length of wire.

16. The display of claim 15 comprising more than one display sign and more than two wire sign holders and consisting of one display rack.

17. The display of claim 16, wherein a first display sign of said more than one display sign is attached to (i) the second hook of a first wire sign holder of said and more than two wire sign holders and (ii) the first hook of a second wire sign holder of said and more than two wire sign holders.

18. The display of claim 17, wherein a second display sign of said more than one display sign is attached to (i) the second hook of the second wire sign holder of said and more than two wire sign holders and (ii) the first hook of a third wire sign holder of said and more than two wire sign holders.

19. A method of hanging a display sign comprising:
(a) forming one or more wire sign holders;
(b) vertically securing said one or more wire sign holders to a display rack; and
(c) hanging one or more signs on the one or more wire sign holders, thereby securing
said one or more signs in a display position,
wherein said one or more wire sign holders each comprise (i) a first length of a wire having a first end and a second end, (ii) a first hook proximate to the first end of the first length of wire, and (iii) a bracket proximate to the second end of the first length of wire, and
wherein each of said one or more wire sign holders is attached to said display rack by securing the bracket to the display rack.

20. The method of claim 19, wherein said bracket comprises a securing mechanism that passes through the bracket and into the display rack, the step of vertically securing said one or more wire sign holders to a display rack comprising tightening said securing mechanism.
